(19) United States
(12) Patent Application Publication
(10) Pub. No.: US 2009/0254575 A1
(43) Pub. Date: Oct. 8, 2009

(54) APPARATUS AND METHOD FOR MANIPULATING NESTED ARCHIVE FILES AND FOLDERS

(75) Inventor: Pavel KRAVETS, Ashdod (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: SAP PORTALS ISRAEL LTD., Ra'anana (IL)

(21) Appl. No.: 12/060,883

(22) Filed: Apr. 2, 2008

(51) Int. Cl. G06F 12/16; G06F 12/00; G06F 7/00; G06F 17/30

(52) U.S. Cl. 707/101; 707/200; 707/204; 707/E17.008; 707/E17.002

(57) ABSTRACT

Methods for packing and unpacking files in a multi-level hierarchy in single actions. The methods operate in memory through using one file pointer for the archive file in recursive calls to the packing and unpacking methods, for accessing files in multiple nested levels. The packing and unpacking are performed in memory, and no temporary files are written to a storage device, thus saving on storage and processing time. A user can also store or retrieve files selectively from an archive file.

### TECHNICAL FIELD

The present disclosure relates to archive files in general, and to methods for creating and handling archive files and folders in particular.

### BACKGROUND

An archive file is a file that packs together a plurality of files. In other words, several files are contained into an archive file, or a series of archive files, for easier or more efficient transfer or storage. Some archiving methods pack the files as is, while others use lossy or lossless compression methods, in order to reduce the archive's size. For example, Huffman coding is used when converting one or more files into a ZIP file. Archive files may be created by programs in various operating systems, such as ZIP in Windows, Tar in Linux, SQ in ms-dos, and others. Some archive formats or methods may be used in multiple operating systems.

Archive files are common in programming environments, for example in compilation or other build products, having suffixes such as EAR, SDA, SCA, SAR, WAR and others. In some cases, it is required to archive files in multiple levels, i.e., several archive files are contained into an archive file, and the archive file is packed with other files into another archive file. When a first archive file is packed into a second archive file, the first archive file is assigned level two and the second archive file is assigned level one. Multi-level archive files are often the result of packing a folder hierarchy in which one or more folders contain files and optionally further folders. The number of levels is unlimited, and complex programs in some programming environments can generate even ten or more file and folder levels, which are to be packed into a single file for transfer and installation purposes.

In archive files environment, packing is the process of combining one or more files into an archive file, and unpacking is the process of retrieving the files that were previously packed into the archive file. Unpacking may also require the creation of one or more folders for storing one or more of the files.

Accessing a file contained within several levels of archive files is time consuming. Further, accessing a file nested in an archive file requires manual effort, as directly accessing a file within an archive file is currently impossible. Accessing files within an archive file is required, for example, for restoring a file, manipulating it, analyzing it or replacing it with another. Thus, such file can be viewed or manipulated only after an unpacking process of one or more levels.

Further, it is sometimes required to retrieve only a portion of the files within an archive file, or to update one or more files within an archive file, while leaving other files and the files hierarchy as is, which is not supported by existing archiving solutions.

It is thus required to provide a method for automatically archiving and retrieving a multiple level file and folder hierarchy into and from an archive file.

### SUMMARY

A method and apparatus for packing and unpacking a hierarchy of files and folders, in which the files and folders are packed and unpacked in memory, and only the final products are written to disk, thus saving on storage time and space, and enabling multilevel packing and unpacking in a single action.

One aspect of the disclosure relates to a method executed by a computing platform, for unpacking a multi level archive file into a folder, the method comprising the steps of: opening the multi level archive file for reading; a. setting a file pointer to point at the beginning of the multi level archive file; b. reading one or more entities from the archive file; c. if one entity is a single file, retrieving the single file details; d. if one entity is an archive file, activating the method starting at step c for the entity; e. advancing the file pointer to the end of the entity; and closing the multi level archive file. Within the method, activating the method for the one entity optionally comprises a recursive or a recursive-like call. Within the method, the file pointer is optionally passed to and from the recursive or recursive-like call as a parameter. The method optionally comprises a step of activating an archiving method. The archiving method is optionally indicated in a script, a registry entry, or a configuration file. The archiving method is optionally selected from the group consisting of: ZIP; JAR; WAR; EAR; SCA; and SDA. The method can further comprise a step of storing the single file on a storage device. Within the single file to be stored is optionally identified according to a rule. The rule optionally relates to one or more items selected from the group consisting of: a file name; a filename suffix; a file type; a file path; a file author; a file creation date; and a file modification date. The method optionally comprises the step of presenting to a user the single file details. Within the method, the user can indicate one or more files to be stored. The method optionally comprises a step of decompressing the single file, or a step of creating a folder in which the single file is stored, or a step of generating a unique file name by concatenating details related to the single file. Within the method, the single file is optionally stored only if the single file was modified after another file was modified. The method is optionally performed in a memory device of the computing platform.

Another aspect of the disclosure relates to a method executed by a computing platform, for packing a multi level file hierarchy into an archive file, the method comprising the steps of: a. opening the archive file for writing; be determining one or more entities to be packed; c. if one entity is a single file to be archived, appending the file contents to the archive file; d. if the entity is a folder, activating the method starting at step c for the folder; e. advancing a file pointer associated with the archive file to point after the file contents; f. writing the archive file to disk; and g. closing the archive file. Within the method, activating the method for each entity optionally comprises a recursive or a recursive-like call. Within the method, the file pointer is optionally passed to and from the recursive or recursive-like call as a parameter. The method optionally comprises a step of activating an archiving method. The archiving method is optionally indicated in a script, a registry entry, or a configuration file. The archiving method is optionally selected from the group consisting of: ZIP; JAR; WAR; EAR; SCA; and SDA. Within the method, it is optionally determined whether the single file is to be archived according to a rule. The rule optionally relates to one or more items selected from the group consisting of: a file name; a filename suffix; a file type; a file path; a file author; a file creation date; and a file modification date. The method can further comprise a step of compressing the single file. The method is optionally performed in a memory device of the computing platform.

Yet another aspect of the disclosure relates to a computer readable storage medium containing a set of instructions for a general purpose computer, the set of instructions comprising: a. opening a multi level archive file for reading; b. setting a file pointer to point at the beginning of the multi level archive file; c. reading one or more entities from the archive file; d. if any entity is a single file, retrieving the single file details; e. if any entity is an archive file, activating the method starting at step c for the entity; f. advancing the file pointer to the end of the entity; and g. closing the multi level archive file.

Yet another aspect of the disclosure relates to a computer readable storage medium containing a set of instructions for a general purpose computer, the set of instructions comprising: a. opening an archive file for reading; b. determining one or more entities to be packed; c. if any entity is a single file to be archived, appending the file contents to the archive file; d. if the entity is a folder, activating the method starting at step c for the folder; c. advancing a file pointer associated with the archive file to point after the file contents; f. writing the archive file to disk; and g. closing the archive file.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 is an illustration of computerized elements implementing methods for packing and unpacking a multilevel archive file;

FIG. 2 is an illustration of a zip file unpacked into a folder, in accordance with an exemplary embodiment of the disclosed subject matter;

FIG. 3 is an illustration of a folder packed into an archive file, in accordance with an exemplary embodiment of the disclosed subject matter;

FIG. 4 is a schematic illustration of memory addresses of several archive files and pointers used for packing the same, in accordance with an exemplary embodiment of the disclosed subject matter;

FIG. 5 is an exemplary method for unpacking an archive file, according to an exemplary embodiment of the disclosed subject matter; and

FIG. 6 is an exemplary method for packing a folder, according to an exemplary embodiment of the disclosed subject matter.

### DETAILED DESCRIPTION

The technical problem dealt with in the disclosed subject matter is the effort, time, and computational resources required for accessing a file in a nested multilevel archive file. Another technical problem is the inability to pack or unpack a nested multi level archive file or folder in one process, especially without using temporary files and folders. In other words, a command for unpacking provides for unpacking the files only one level below the archive file, and not files contained within archive files, which are themselves contained within the handled multilevel archive file. A file cannot be accessed within an archive file; hence, in order to manipulate the file or read it, the archive files containing the handled file are to be unpacked one level at a time.

One technical solution suggested in the subject matter is a method for unpacking a multilevel archive file. Unpacking is performed by a computerized entity such as a computing platform executing a computerized program, application, function, routing, object-method, or the like. When unpacking a multilevel archive file, the entire multilevel archive file is opened for reading, reviewed or scanned, and files and folders within the multilevel archive file are identified. The application preferably determines which files should be retrieved based upon metadata related to the files and folders, or on user's preferences. When the archive file is opened, its whole contents are read into the memory, and the non-archive file are scanned by advancing the file pointer associated with the file while being read. In an exemplary embodiment of the subject matter when the application identifies an archive file within the multilevel archive file, the same computerized program is called recursively with the same archive file, but with the file pointer pointing at the internal (nested) archive file. Then, the files within the detected archive file are identified in the same manner as the file in upper levels. No temporary files are written for the scanned files. When calling the program recursively, the file pointer or a memory address is preferably passed as a parameter, global variable or otherwise accessible data. In other words, when detecting an archive file during the process of unpacking, the application unpacks the detected archive file, and then continues reviewing the rest of the files.

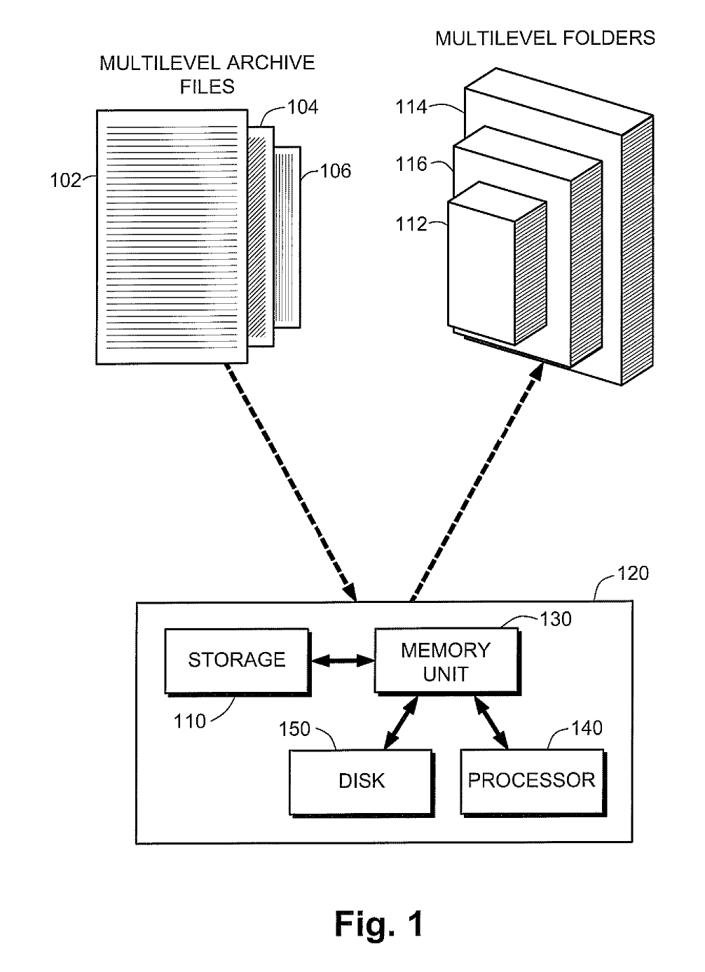

Referring to FIG. 1, schematically illustrating computerized elements implementing methods for packing and unpacking a multilevel archive file. The computerized environment comprises storage unit 110, such as a disk, hard disk, flash memory and the like, in which a multilevel archive file is stored. Storage unit 110 may also contain a set of rules used for determining which files to retrieve from the multilevel archive file. Storage unit 110 may be located within a computerized entity 120, or communicate with such computerized entity, either directly or via a third party entity. Computerized entity 120 can be a personal computer, laptop, server, phone, database connected to a memory, or any other entity comprising a memory unit 130 and a processor 140. When a multilevel archive file 102 is required to be unpacked, for example due to a user request or due to the execution of a computer application, processor 140 sends a command to open the multilevel archive file for reading. Then, processor 140 starts reviewing the files within the multilevel archive file. Some of the files within the multilevel archive file may be archive files containing further files, such as archive file 106 comprising file 104. When a file within multilevel archive file 102 is reviewed, metadata related to the file is preferably sent to the processor or another entity such as a calling program. The files to be unpacked may be determined by a user of an application executing the unpacking process, by a user of an application associated with packed files that should be accessed, or automatically according to predetermined preferences.

When unpacking archive file 102, the whole file is read into memory 130, and processor 140 allocates a file pointer to point at the memory address from which files are to be read. Each file within archive file 102 is scanned, and the file details, including the beginning and end locations of the file within file 102 and the path (hierarchy) of the file within the archive file, are stored. The file pointer is advanced to the end of the scanned file, and the scanning of archive file 102 continues. When an archive file 104 is detected in multilevel archive file 102, the files within the detected archive file are reviewed by calling the same program or routine in a recursive manner, extracting details of further files, and advancing the file pointer. When all the files in multilevel archive file 102 are reviewed, the details are presented to a user or to a program. The files to be retrieved are accessed according to the determined locations within archive file 102, and written to storage unit 110. A folder hierarchy 114 is constructed that matches the hierarchy of the files to be restored, and the files are written to the respective folder, according to a file hierarchy. The restored files may be amended or replaced by other files and packed again.

The computerized elements are also required for packing a multi level folder 114 into a multilevel archive file 102. Multi level folder 114 may have been previously generated during the process of unpacking a multilevel archive file as described above, or in any other method. Processor 140 opens an archive file 102 for writing, reads files from the multi level folder hierarchy 114 and reads the contents of the files into the memory, at the address pointed to by file pointer of file 102. When folder 116 is detected within the multi level folder 114, the program is called recursively, with the file pointer of file 102 passed as a parameter, and the files within folder 116 are reviewed. Processor 140 continues reviewing files within folder 116, such as further folder 112, and further files contained within folder 114.

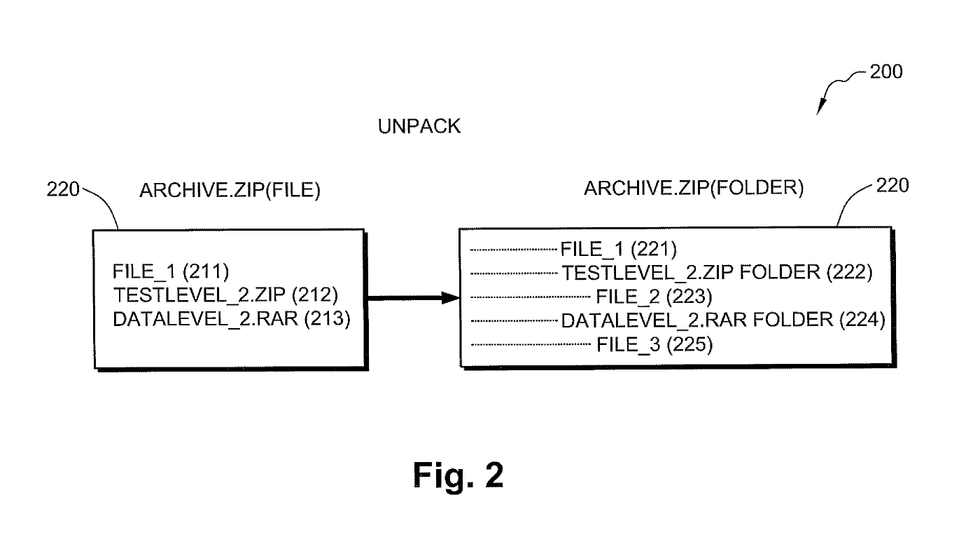

Referring now to FIG. 2, schematically illustrating an archive file unpacked into a folder. The described files and folders are read, written and manipulated by a computerized entity such as a personal computer (PC), server, laptop, blackberry, cell phone, or any other computing device equipped with CPU and memory. Archive file 210 (Archive.zip) comprises a file File_{—}1 (211), and two archive files testLevel_{—}2.zip (212) and dataLevel_{—}2.rar (213). TestLevel_{—}2.zip (212) is an archive file that has been archived using a ZIP method, and dataLevel_{—}2.rar (213) is an archive file that was archived using a RAR method. TestLevel_{—}2.zip (212) or dataLevel_{—}2.rar (213) comprise additional files, one or more of which may also be archive files. In prior art solutions for unpacking an archive file into a folder, archive files contained within the packed archive file were restored as archive files. The current disclosure enables the nested or multilevel unpacking of files archived within the packed file.

The processes of packing and unpacking archive files are preferably performed in the memory of the computing platform, and the only files written to disk are the packed archive file when packing a folder hierarchy, and the files that have to be restored when unpacking an archive file. Handling the process in the memory level is enabled by manipulating file pointers or other memory addresses instead of copying the data within the files. When a file is packed or unpacked, preferably a single file pointer is created, the file pointer is transferred to recursive calls of the packing or unpacking routines, and is updated by the routines.

In an exemplary embodiment of the unpacking process, the archive file is opened for reading and a file pointer is assigned, which initially points at the beginning of the file. When an archive file is detected within the open archive file, the computerized entity or the processor calls the unpacking routine in a recursive manner. The routine receives as a parameter or another indication concerning a memory address, a file pointer pointing at the beginning of the nested archive file. The routine traverses the files within the nested archive, and optionally further nested archives within the archives and updates the file pointer to point at the memory address of the end of the nested archive file within the open archive file. When all files or further archive files are reviewed, the routine returns the file pointer positioned after the archive file and may also return metadata related to files within the multilevel archive file. The user or the application then optionally indicate which files or folders are to be retrieved. Files that should not be unpacked are not retrieved or stored, thus saving storage time and disk space. Each file that has to be retrieved is retrieved by positioning the file pointer in the location associated with the beginning of the file, reading the contents and storing them in the relevant folder on the disk. If no such folder exists, the folder is created. By handling data in the memory level, the writing into the disk is performed only for files determined to be unpacked, thus avoiding unnecessary unpacking. After unpacking Archive.zip file 210, the result is folder 220 comprising the files packed within Archive.zip zip file 210 and additional files, or folders comprising other files. In the example of FIG. 1, each folder comprises a file that can be accessed directly, without requiring explicit unpacking of testLevel_{—}2.zip or dataLevel_{—}2.rar as required in prior art solutions.

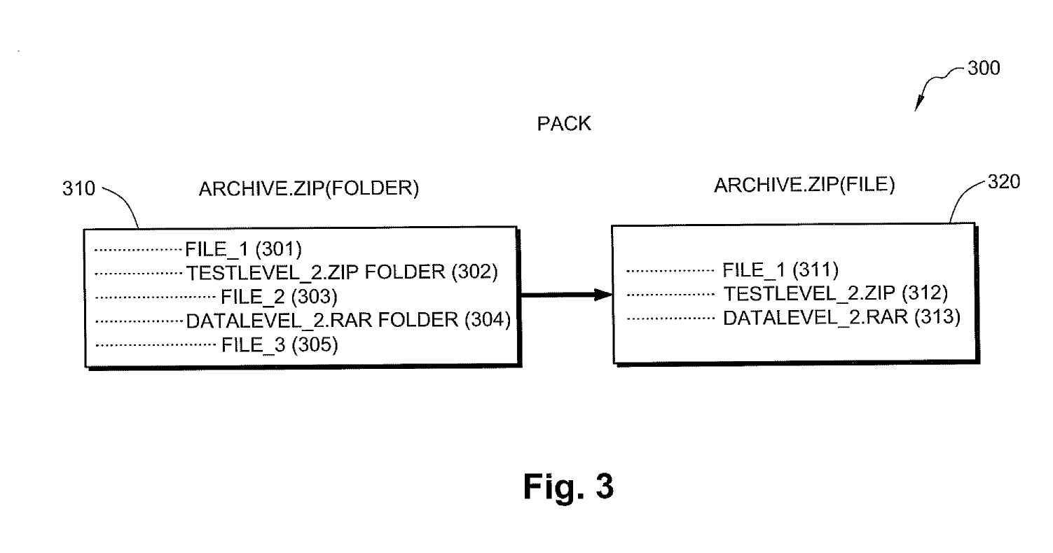

Referring to FIG. 3, schematically illustrating a computerized environment 300, in which a folder is packed into an archived file. Archive.zip folder 310 comprises two levels of files and folders. In the first level, there is one file, File_1 (301), and two folders, testLevel_{—}2.zip (302) and dataLevel_{—}2.rar (304). Each folder comprises a file, located in the second level under folder Archive.zip 310. TestLevel_{—}2.zip (302) comprises File_{—}2 (303) and dataLevel_{—}2.rar (304) comprises File_{—}3 (305).

The computerized application executing the packing process opens a file for writing and associates a file pointer with the file. Then, the application traverses the files and folders within the folder to be packed, and determines the files to be packed. The application optionally enables a user or an application to indicate which files are to be packed.

In case a regular file is to be packed, i.e. not an archive file or a folder, the file is read to memory. An entity object, such as a Java entity is created which wraps the object. The entity object preferably comprises the content of the file, and metadata such as the file name, size, creation date and other details. The object is then appended to the archive file open in memory, starting at the address pointed by the file pointer. After a file is appended to the archive file, the file pointer is advanced to the end of the archive file. In case an object to be packed is a folder, the process is performed recursively. The program or routine are called recursively for the folder, and the file pointer as updated after previous files or folders were appended is passed as a parameter, a global variable, or the like, to the program or routine. The pointer is updated to point at a memory address in which the next file is to be appended to the archive. After the files within the folder are packed, the pointer is advanced to the end of the file, and further files or folders can be packed.

In some embodiments of the subject matter, additional data is logged when packing archive files. For example, the number of files or archive files within an archive file, the level of archive files, full or relative file paths, memory address, files type, files size, data related to folders and the like. Such additional data may be used when unpacking data, for efficient memory usage. For example, unpacking may be performed only for files with specific name or suffix, stored when the files are packed. In case such name, file type or suffix is logged or associated with an archive file, it may facilitate unpacking relevant files only.

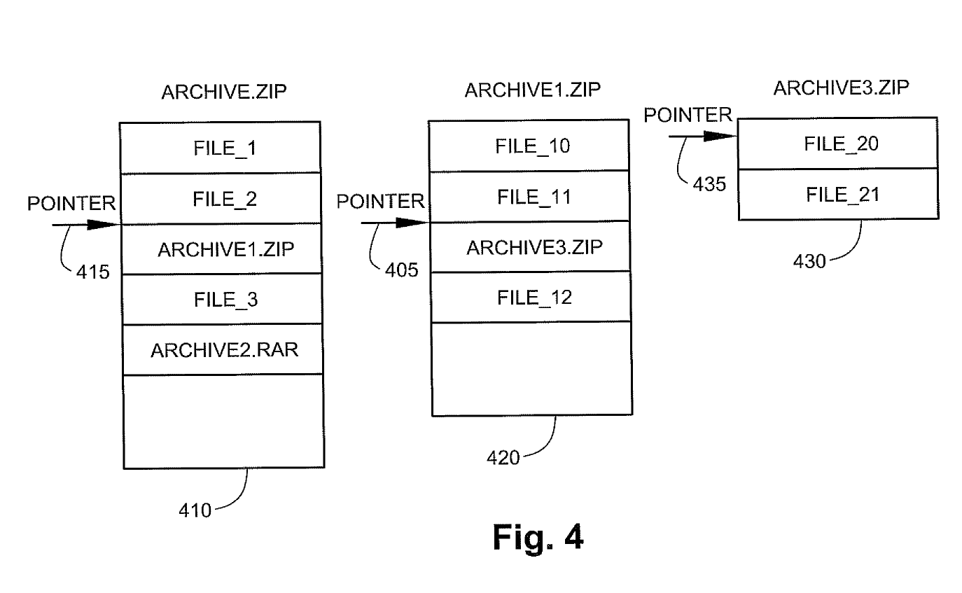

Referring now to FIG. 4, illustrating a schematic embodiment of an archive file and files comprised within the archive file. Archive.zip 410 is an archive file that comprises three files, file_{—}1, file_{—}2 and file_{—}3, and two archive files, Archive1.zip detailed as 420 and Archive2.rar. The archive files are archived using two different methods, RAR and ZIP. When unpacking Archive.zip 410, Archive.zip 410 is opened. The various files, including file_{—}1 and file_{—}2 within the archive file are recognized for example by creating entity objects such as the entity objects with which the file was created or compatible ones, and reading from Archive.zip 410 into the entity object. A file pointer is allocated and initially set to point at the memory address at which file_{—}1 starts. Then file_{—}1 and file_{—}2 are read one after the other into entity objects, and their details, including the start and end points within the file, a path, or other parameters are stored. After reading a file into an object, the file pointer is advanced to point at the memory address at which the next file or folder is to be read from.

When unpacking Archive.zip 410, a file pointer is allocated and set to point at the beginning of Archive.zip 410. When the application detects an internal archive file within the main archive file, the internal archive file is reviewed. Therefore, when Archive1.zip 420 is detected within Archive.zip 410, the file pointer is assigned to point at memory address 415 at which Archive1.zip 420 starts within Archive1.zip 420, and the program or routine is called recursively. Then File_{—}10 and File_{—}11 are detected and read from the memory address 415 pointed by the file pointer. Next, Archive3.zip is detected. The file pointer is set to point at address 405 and the routine is called recursively, i.e. a third nested call of the routine, for archive3.zip 430 with address 405 as a parameter. Then files File_{—}20 and File_{—}21 are retrieved. The third call returns with the file pointer pointing at the beginning of file 12, file 12 is read and the second call returns with the file pointer pointing at the beginning of file_{—}3. File_{—}3 is then read and wrapped by an entity object, after which the program or routine is called recursively to handle archive3.rar.

After the files are read into memory, those files that should be retrieved are written to the disk. The files to be retrieved are optionally determined by a set of rules. In another preferred embodiment, the data related to the files is presented to a user or sent to a program, and the user or program determine which files should be retrieved. The result of the process is one or more files or folders comprising the previously archived files. The folders may also store data related to the archiving method, memory addresses of the files within the folder, date in which the unpacking was performed, date when the files were modified and the like.

The unpacked files may be stored in folders as shown in FIG. 2. Alternatively, the files are stored in a flat list rather than a hierarchy, and the name of each file is appended or prefixed or postfixed with a path or level or other data that may be useful for packing the files in the same structure as packed in the archive files. For example, File_{—}20 can be assigned a level number value “3” and a predecessor value “Archive3.zip”, such that it's name can be archive3.zip_level_3_file_{—}20. This naming convention enables unpacking the files in the same level and accessing the files in the file system in a single level.

Various archive methods may be identified and considered during packing or unpacking. The various methods can be indicated in a file, such as an XML file. The file may comprise archiving method indications, and preferred file suffixes identifying files that should be packed or unpacked using the respective archiving method. Thus, adding an indication for a new archiving method, and optionally a path to a program performing the archiving will enable the method and apparatus to operate with the additional method and apply the method to the required files. Each method can also compress the respective file, in addition to archiving it.

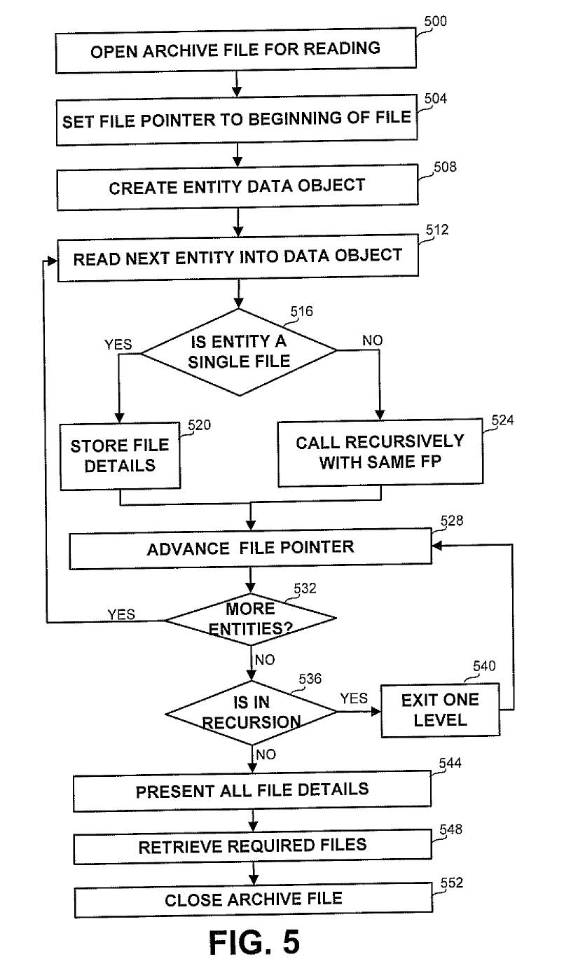

Referring now to FIG. 5, illustrating a schematic embodiment of a method for unpacking a possibly multi-level archive file, i.e. an archive file that optionally comprises further archive files. On step 500, the computerized entity such as the program that performs the unpacking process opens the archive file, which is optionally a multi-level archive file for reading. An archive file comprises a sequential collection of entities. On step 504, the file pointer (FP) associated with the open archive file is set to point at the beginning of the file. This step may be omitted if the FP is automatically set to point at the beginning of is a file when the file is opened. On step 508, a data object is created in memory, for each file encountered in the archive file. The data entity may be implemented as a java entity. On step 512 the next entity is read from the open archive file into the data object. On step 516 it is determined whether the read entity is a single file or a combination of multiple files, such as a further archive, a folder, or the like. If the entity is a single file, then on step 520 the file details, including for example the file name, type, size, prefix, suffix, last date in which a file was modified, related files, start and end location within the file, the full or relative file path, author's name, version, a combination thereof or the like are collected or logged, for example in a dedicated list. The details are preferably retrieved from the archive file and read as part of the data object. If the entity is detected to be a complex file or a folder, the method, program or other executing unit is called recursively on step 524, but steps 500 and 504 are not performed, i.e. the archive file is already open and cannot be re-opened, and the file pointer is not moved to the beginning of the file. When the program is called recursively, details referring to further files embedded within the archive or folder are collected. After each entity is processed, whether it is a single file or recursively if it is a folder or a further archive: on step 528 the FP is advanced to point at the location in the archive file after the last entity read. On step 532 it is determined whether there are further entities, i.e. files or folders to be read into the data object. If the execution is in a recursive level, it is determined whether there are any more objects in the previously read data object. If there are more objects, the process repeats. Otherwise, it is determined in step 536 whether the current execution is on the top level or on a recursive level. If it is on a recursive level, execution exits one level on step 540 and returns to step 528 of the previous level. Otherwise, if execution is on the top level and there are no more entities, then on step 544 the details of all files are presented to a user, sent to a program or otherwise used. On step 548 the files selected by a user or by a program are retrieved by activating any relevant archiving method, and stored on a storage device, such as a disk. The archiving method is determined for example according to the suffix of the files, to a default archiving method, as indicated for the whole archive file, or the like. The available archiving methods are preferably indicated in a script file, configuration file, registry entry, or the like, such that additional methods can be used by updating the available archiving methods. The files are stored using the relevant details retrieved on step 520, including for example their start and end locations within the archive file, path, or the like. Thus, in order to retrieve the file contents the starting location of the file within the archive file is accessed, and the contents are retrieved until the end location of the file. If a file's path, as optionally indicated in the archive file does not exist, the relevant folder or folder hierarchy are created and the file is stored in the correct directory. Alternatively, a name is generated for each file which uniquely identifies it, for example by concatenating the names of all folders in the hierarchy of the file, and all files are stored in a flat hierarchy but with names indicative if the hierarchy. In a preferred embodiment, if the files to be restored are determined according to a rule relating for example to the file extension, or for example if all files are to be restored, the files are preferably retrieved on step 520, and steps 544 and 548 are omitted. If a file to be retrieved is compressed, then as part of the retrieval the relevant decompression method is called for decompressing the file and the storing it on the disk. On step 552 the archive file is closed.

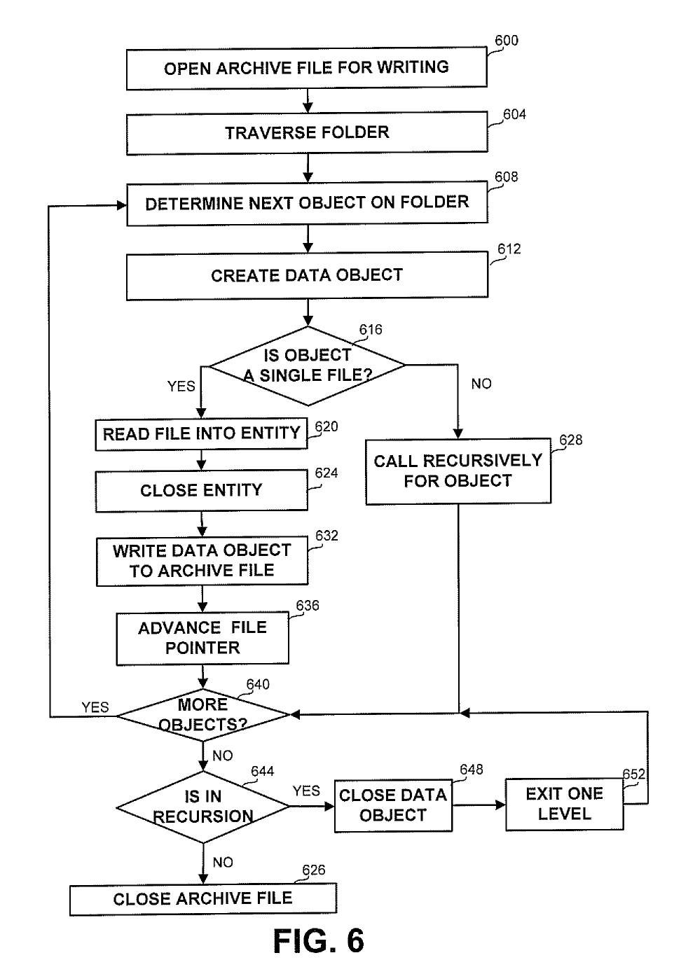

Referring now to FIG. 6, illustrating a schematic embodiment of a method for packing files from a multilevel folder. On step 600 an archive file is created and opened for writing. On step 604, traversing of the folder to be packed starts. On step 608 the next object within the folder is determined, according for example to the name, date, any other parameter or an arbitrary order. On step 612 a data object is created, such as a Java entity, as detailed in association with FIG. 5 above. For the object determined in step 612, it is determined on step 616 whether the object is a single file or a folder. A file which in itself packs one or more files, is still considered a single file. If the object is a single file, the file is read into memory, and wrapped by the data object on step 620. On step 624 the data object is closed, on step 632 the data object is written into the open archive file preferably along with metadata related to the file such as name, size, location within the file, author, version, or the like, and on step 636 the FP is advanced to the end of the newly written data. If the object is a folder, then on step 628 the process is called recursively for the folder. The recursive call is performed without changing the value of FP, so that writing to the file continues from the same location, and when the recursive call returns, the FP is updated to the end of the written objects. On step 640 it is determined whether there are more objects on the current level. If there are, the process returns to step 608 and repeats for the next object. If there are no more objects on the current level, on step 644 it is determined whether the process is in a recursion level higher than one, i.e. is it operating on a descendent folder of the original folder to be packed. If processing is in a recursion level, then on step 648 the current data entity is closed. This data entity is a wrapper entity comprising one or more data entities generated and written for files within the current folder. On step 652 execution returns to the previous level. If there are no more files, and execution is in the top level, then the archive file is closed on step 626 and the process stops.

In a preferred embodiment of the disclosure, only files determined by a user, by a program, by a rule or in any other method are written to the archive file. In yet another preferred embodiment, if a file within the archive file is to be retrieved to a folder, and a file with that name already exists in the folder, optionally only if the file within the archive is newer than the file in the folder, the file will be overwritten, otherwise the existing file will remain.

The methods disclosed in FIG. 5 an din FIG. 6 above are preferably executed by software or hardware components written in any programming language such as C, C#, C++, Java, VB, VB.Net, or the like, and developed under any development environment, such as Visual Studio.Net, J2EE or the like. Each of the computing platforms on which packing or unpacking methods are executed is preferably a computing platform, such as a personal computer, a mainframe computer, or any other type of computing platform that is provisioned with a memory device (not shown) and a CPU or microprocessor device. It will be appreciated that the methods can alternatively be implemented as firmware ported for a specific processor such as digital signal processor (DSP) or microcontrollers, or can be implemented as hardware or configurable hardware such as field programmable gate array (FPGA) or application specific integrated circuit (ASIC).

A person skilled in the art will appreciate that the disclosed methods can use recursive-like programming techniques, and are not limited to computing environments and languages that provide built-in recursion.

The disclosed methods of packing and unpacking multiple files enable efficiency and resource consumption in packing and unpacking files. The process is preferably done only in memory, without writing unnecessary files to the disk. No temporary files are stored on the disk during packing, thus requiring less temporary disk space and saving storage time.

The disclosed methods also provide for efficiency by enabling the packing and unpacking of multiple-level hierarchy in a single action. When unpacking, a multi-level file and folder hierarchy can be unpacked by a single action, without having to unpack one level after the other. Thus, in order to update a single file packed in an archive file, the archive is opened with a single action, the file is manipulated or replaced, and the whole hierarchy is packed back with a single action. The disclosed methods can operate with any packing and/or compressions method, including but not limited to ARJ, RAR, ZIP, WAR, EAR, SCA, SDA or any other archive method, preferably based on the zip algorithm. Adding additional packing methods is preferably done by updating a script, XML file, or the like.

Further, it is possible to pack or unpack only files of a certain type, files having predetermined prefix or suffix, files adhering with one or more rules, or files specifically indicated by a user.

The disclosed methods is also useful in preventing viruses from being written to the disk, since the user can review the files within the archive, decide which ones should be retrieved and avoid retrieving suspicious files.

The methods and apparatus disclosed in the subject matter may be implemented in various operating systems, among which are windows versions, Linux, Solaris and derivatives of the above.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this disclosure, but only by the claims that follow.

1. A method executed by a computing platform, for unpacking a multi level archive file into a folder, the method comprising the steps of.
a. opening the multi level archive file for reading;
b. setting a file pointer to point at the beginning of the multi level archive file;
c. reading an at least one entity from the archive file;
d. if the at least one entity is a single file, retrieving the single file details;
e. if the at least one entity is an archive file, activating the method starting at step c for the at least one entity;
f. advancing the file pointer to the end of the at least one entity; and
g. closing the multi level archive file.

2. The method of claim 1 wherein activating the method for the at least one entity comprises a recursive or a recursive-like call.

3. The method of claim 2 wherein the file pointer is passed to and from the recursive or recursive-like call as a parameter.

4. The method of claim 1 further comprising a step of activating an archiving method.

5. The method of claim 4 wherein the archiving method is indicated in a script, a registry entry, or a configuration file.

6. The method of claim 4 wherein the archiving method is selected from the group consisting of: ZIP; JAR; WAR; EAR; SCA; and SDA.

7. The method of claim 1 further comprising the step of storing the single file on a storage device.

8. The method of claim 7 wherein the single file to be stored is identified according to a rule.

9. The method of claim 8 wherein the rule relates to one or more items selected from the group consisting of: a file name; a filename suffix; a file type; a file path; a file author; a file creation date; and a file modification date.

10. The method of claim 1 further comprising the step of presenting to a user the single file details.

11. The method of claim 10 wherein the user can indicate an at least one file to be stored.

12. The method of claim 7 further comprising a step of decompressing the single file.

13. The method of claim 7 further comprising a step of creating a folder in which the single file is stored.

14. The method of claim 7 further comprising a step of generating a unique file name by concatenating details related to the single file.

15. The method of claim 4 wherein the single file is stored only if the single file was modified after another file was modified.

16. The method of claim 1 wherein the method is performed in a memory device of the computing platform.

17. A method executed by a computing platform, for packing a multi level file hierarchy into an archive file, the method comprising the steps of:
a. opening the archive file for writing;
b. determining an at least one entity to be packed;
c. if the at least one entity is a single file to be archived, appending the file contents to the archive file;
d. if the at least one entity is a folder, activating the method starting at step c for the folder;
e. advancing a file pointer associated with the archive file to point after the file contents;
f. writing the archive file to disk; and
g. closing the archive file.

18. The method of claim 17 wherein activating the method for the at least one entity comprises a recursive or a recursive-like call.

19. The method of claim 18 wherein the file pointer is passed to and from the recursive or recursive-like call as a parameter.

20. The method of claim 17 further comprising a step of activating an archiving method.

21. The method of claim 20 wherein the archiving method is indicated in a script, a registry entry, or a configuration file.

22. The method of claim 20 wherein the archiving method is selected from the group consisting of: ZIP; JAR; WAR; EAR; SCA; and SDA.

23. The method of claim 17 wherein it is determined whether the single file is to be archived according to a rule.

24. The method of claim 23 wherein the rule relates to one or more items selected from the group consisting of: a file name; a filename suffix; a file type; a file path; a file author; a file creation date; and a file modification date.

25. The method of claim 17 further comprising a step of compressing the single file.

26. The method of claim 17 wherein the method is performed in a memory device of the computing platform.

27. A computer readable storage medium containing a set of instructions for a general purpose computer, the set of instructions comprising:
a. opening a multi level archive file for reading;
b. setting a file pointer to point at the beginning of the multi level archive file;
c. reading an at least one entity from the archive file;
d. if the at least one entity is a single file, retrieving the single file details;
e. if the at least one entity is an archive file, activating the method starting at step c for the at least one entity;
f. advancing the file pointer to the end of the at least one entity; and
g. closing the multi level archive file.

28. A computer readable storage medium containing a set of instructions for a general purpose computer, the set of instructions comprising:
a. opening an archive file for reading;
b. determining an at least one entity to be packed;
c. if the at least one entity is a single file to be archived, appending the file contents to the archive file;
d. if the at least one entity is a folder, activating the method starting at step c for the folder;
e. advancing a file pointer associated with the archive file to point after the file contents;
f. writing the archive file to disk; and
g. closing the archive file.
